(19) United States
(12) Patent Application Publication
(10) Pub. No.: US 2012/0219378 A1
(43) Pub. Date: Aug. 30, 2012

(54) Fastening System

(76) Inventor: Rahul Saggar, Brooklyn, NY (US)

(21) Appl. No.: 13/399,990

(22) Filed: Feb. 17, 2012

Related U.S. Application Data
(60) Provisional application No. 61/463,780, filed on Feb. 19, 2011.

(51) Int. Cl. F16B 21/00

(52) U.S. Cl. 411/337

(57) ABSTRACT

A fastening system using surfacing on the contact faces of the fastening system components in order to aid in the installation of the system. In addition, the may resemble an installed rivet. The system consists of a bolt with or without an engage-able head. The nut can have a rounded exposed surface resembling rivets. The nut is engage-able through methods to resist movement through surface treatment or tool engage-able surfaces that are not visible. The major application is in that of historic restorations, but can also be used in locations where installation accessibility is limited and/or smooth finishes are desired.

### FIELD OF THE INVENTION

This invention relates to construction and in particular to a method of mechanical fastening of two or more objects, usually planar. The system can also be used in applications where a rivet appearance is desired. The invention is made up of the fastening system described below.

### EXISTING ART

The tension controlled fastening system is capable of resembling the rivet appearance on one side of the fastening system, however the engagement side of the system still has an angular head appearance. More specifically, the twist off or tension control bolt described in U.S. Pat. No. 5,108,238 provides a method to engage the shaft of the bolt, however this also requires engagement of the nut in order to achieve proper installation.

Existing fastening systems relying on surfacing or locking mechanisms are designed to resist loosening usually on the nut side of a fastening system. However, the existing art does not address locking mechanisms meant to aid in the installation of the fastening system.

### BACKGROUND OF THE INVENTION

Two of the standard methods of mechanically fastening materials in construction applications is through bolting and riveting. Bolting is still widely used today in applications where welding is not an option. Although riveting was used widely in construction, currently riveting is used in lighter applications due to the difficulty in standardization of quality, such as regulating tension force on rivet shaft, which is especially important in slip critical applications. For many structural applications, bolting is used. The system proposed in this application can be constructed from the machining and/or casting of steel or other metals, plastics, acrylics, or materials capable of being used in fastening applications.

### DESCRIPTION OF DRAWINGS

Two sets of drawing with same titles and notations are provided to show consistency among varied engage-able shaft dimensions. The washer option is not shown as it is meant to use surfacing for the same purpose as that on the contact side of the nut.

FIG. 1 is a section of the bolt and nut. 1 denotes the nut. 2-5 denote portions of the bolt. 2 denotes the shaft of the bolt. 3 denotes the head of the bolt. This can be shaped to resemble a rivet. 4 denotes the engage-able portion of the bolt, similar to that of a tension controlled bolt. It is important to note that in current applications this shaft is much narrower than the threaded portion of the shaft, which can also be done in this system. 5 denotes the threaded portion of the bolt, similar to that of a standard bolt, or a tension controlled bolt.

FIG. 2, shows a perspective view of the nut. 6 denotes the area of the nut that bears. This can be of a variety of surfaces, including a roughened surface that resists movement, such as that similar to a serrated face nut. This surface can also be fashioned such that it is engage-able with a wrench or device to impose torque. This area for torque imposing wrench to engage can be anywhere along the nut.

FIG. 3 shows a perspective view of the bolt. 7 is the engage-able portion similar to that shown in FIG. 1, notation 4. 8 is where the threaded portion of the bolt could be, similar to that show in FIG. 1, notation 5. Note that threading is not represented in drawing. 9 is the head of the bolt similar to that shown in FIG. 1, notation 3.

FIG. 4 shows a perspective view of the fastening system without the material to be joined shown. 10 is the nut. 11 is the shaft of the bolt.

FIG. 5 shows a perspective view of the fastening system with the materials to be fastened shown. 12 is one planar material to be fastened. 13 is another planar material to be fastened. 14 is the nut. 15 is the head of the bolt. 16 is the engage-able portion of the bolt. It is important to note that this has broken away in FIG. 6.

FIG. 6 shows a perspective view of the fastening system in FIG. 5 with the engage-able portion of the bolt gone. 17 denotes of the location of the engage-able portion of the bolt that has been removed. This can be by a break away method or can be cut or grinded away. 18 denotes the nut.

FIG. 7 shows a perspective plan view of the bolt head.

FIGS. 8, 9, 10, 11, and 12 correspond with information shown in FIGS. 2, 3, 4, 5, and 6, respectively. The perspective is changed to further illustrate the invention.

FIG. 8 shows perspective view of nut shown in FIG. 2 from a different vantage point. 19 denotes area of nut that would be threaded.

FIG. 9 shows perspective view of bolt shown in FIG. 3 from a different vantage point. Threading is not shown.

FIG. 10 shows perspective view of fastening system depicted in FIG. 4 from different vantage point. 20 denotes nut.

FIG. 11 shows perspective view of fastening system depicted in FIG. 5 from a different vantage point.

FIG. 12 shows perspective view of fastening system depicted in FIG. 6 from a different vantage point. Surface depicted in 21 can be smoothed.

### VARIATIONS

In addition to the variations mentioned above, the system can be varied such that:

The bolt head denoted by 3, 9 and other notations can be of various curves or angular shapes.

The nut denoted by 6, 10 and other notations can be of various curves and angular shapes.

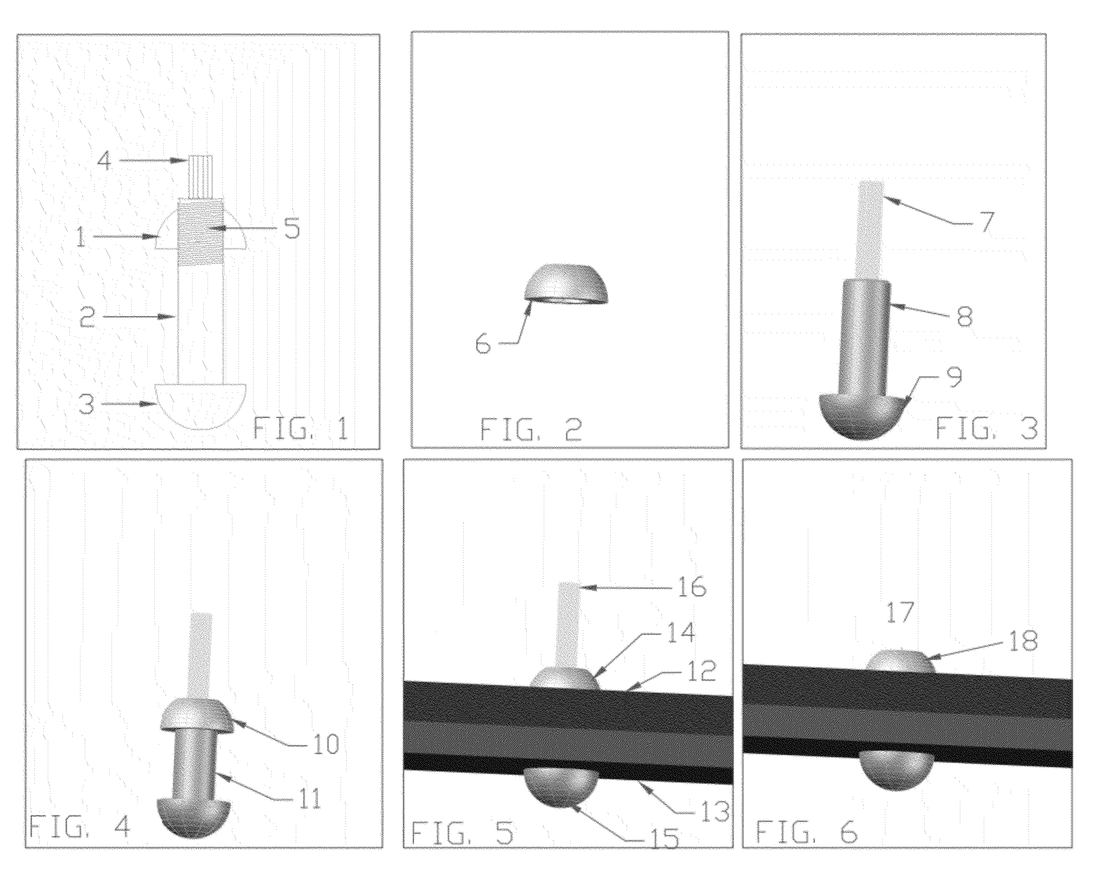

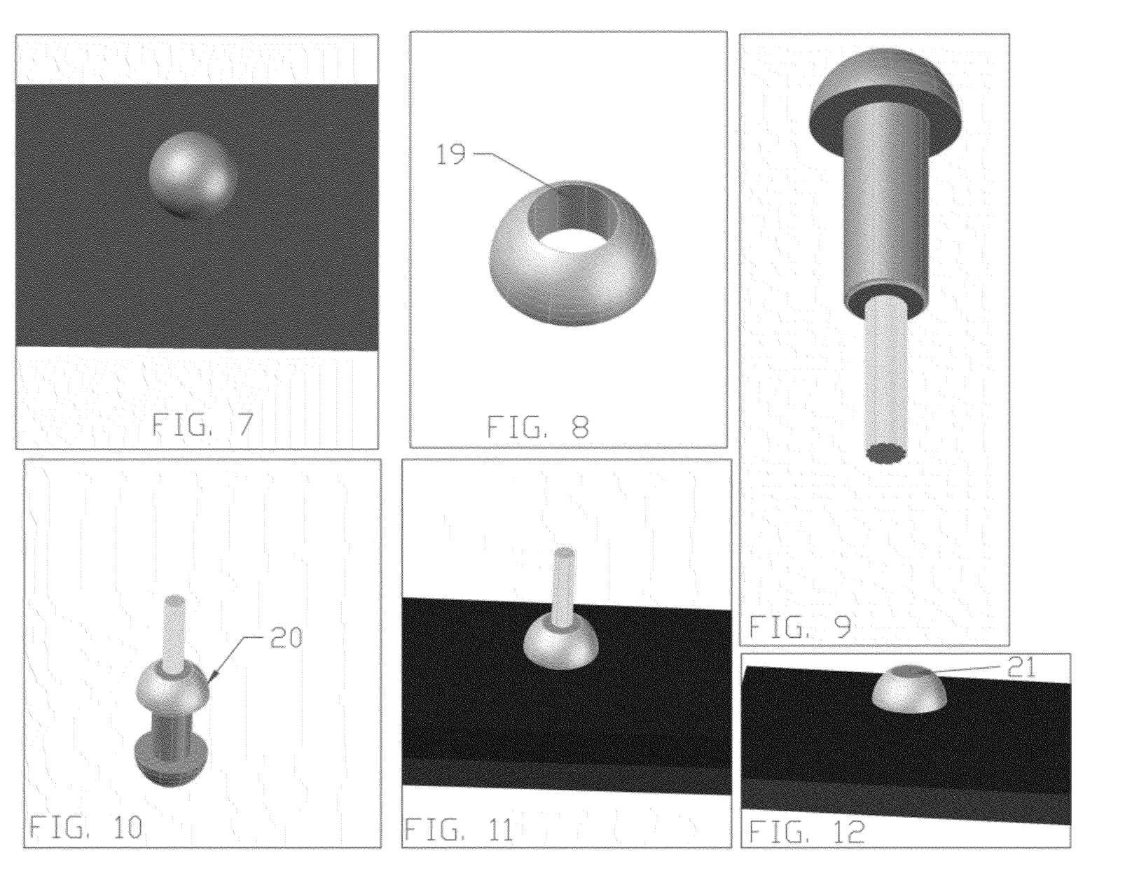

The engage-able portion of bolt shown in FIG. 1, notation 4, can be narrower or wider than the other areas of the bolt shaft. The second set of figures reflects this with all the same notations. In addition this portion does not have to be present.

The number of materials to be fastened, as show in FIG. 5, notations 12 and 13, can be more or less.

Washers, such as lock washers, or variations meant to aid in the installation of the system can be used in conjunction with system.

Materials to be fastened, 12 and 13, do not have to be planar.

Breakaway portion of bolt does not have to coincide with nut height.

System does not have to be based on tension controlled bolt, or breakaway bolt system.

It is understood that the preceding description is given merely by way of illustration and not in limitation of the invention and that various modification may be made thereto without departing from the spirit of the invention.

1. A nut used in a fastening system consisting of a bolt and a nut, such that the nut has surfacing meant to increase friction in order to aid in the installation of the fastening system.

2. A washer used in a fastening system consisting of a bolt, nut, and washer such that the washer is serrated to aid in. the installation of the fastening system.

3. A bolt with a head having a contact surface such that it resists movement in order to aid in the installation of the fastening system.

4. A nut in claim 1 that consists of a surface such that when in contact with material to joined, resists movement to allow tensioning in bolt system to reach slip critical connection requirements.

5. A nut in claim 1 that consists of a method to engage such that movement sisted to allow tensioning in bolt system to reach slip critical connection requirements.

6. (canceled)

7. A nut in claim 1 that consists of an exposed surface resembling hat of a rivet.

8. A nut in claim 2 that consists of an exposed surface resembling that of a rivet.
